(19) United States
(12) Patent Application Publication
(10) Pub. No.: US 2008/0106106 A1
(43) Pub. Date: May 8, 2008

(54) VEHICLE BUMPER HAVING AN INTEGRATED STEP

(76) Inventor: Andre Lavoie, Trois-Rivieres (CA)

Correspondence Address: BERESKIN AND PARR, 40 KING STREET WEST, BOX 401, TORONTO, ON, M5H 3Y2, CA

(21) Appl. No.: 11/935,691

(22) Filed: Nov. 6, 2007

Related U.S. Application Data
(60) Provisional application No. 60/864,432, filed on Nov. 6, 2006.
(60) Provisional application No. 60/870,194, filed on Dec. 15, 2006.

(51) Int. Cl. B60R 19/48

(52) U.S. Cl. 293/117

(57) ABSTRACT

A bumper assembly for an automotive vehicle having a chassis and a longitudinal axis is disclosed. The bumper assembly comprises an elongated frame and a first step pivotally attached to the frame. The elongated frame has a first end, a second end and a hitch clearance area between the first end and the second end. The frame is adapted to be attached to the chassis. The hitch clearance area is at least the width of a trailer hitch. The first step is attached to the frame between the first end and the hitch clearance area. The first step is pivotable from a stored position to a functionally deployed position. The first step is operative to receive at least a person on a stepping face when in the deployed position. The first step is operative to clear a projection of the hitch clearance area in the direction of the longitudinal axis of the vehicle. The step is adapted to be installed laterally off-centered from the vehicle. A vehicle comprising such a step at its rear portion is also disclosed.

### FIELD OF THE INVENTION

The present invention generally relates to the field of automotive vehicles. More specifically, the invention relates to a novel bumper for an automotive vehicle, such as a truck, that transforms into a step for easy access to its cargo area.

### BACKGROUND OF THE INVENTION

Many vehicles such as pick-up trucks and delivery trucks have a cargo floor placed relatively high such that it is sometimes difficult for a person to get easy access to the whole cargo area or to get in the cargo area. Further complicating the access to the cargo area, many of the users of these vehicles, such as contractors, have to haul a trailer to carry additional equipment or materials.

It is known to provide a horizontal surface on a fixed bumper in the rear of such vehicles to provide step access to the cargo area. Most pick-up trucks as well as delivery trucks are so equipped. However, such bumpers may pose an inconvenience as a result of being too high. Indeed, their stepping height is dictated by the height of the top surface of the bumper. Moreover, this bumper arrangement disrupts body surface-to-bumper contour and to some extent is prone to being scratched by people stepping on it, which is detrimental to the appearance of the vehicle.

To remedy the height problem posed by conventional step bumpers, foldable steps have been proposed which fold down from the step area to a lower level, such as disclosed in U.S. Pat. No. 4,194,754 (Hightower) and U.S. Pat. No. 4,198,070 (Weiler). Foldable assemblies attached to a step bumper not only appear bulky and not aesthetically pleasing, but they also increase the complexity and cost of the bumper. The foldable bumper step of U.S. Pat. No. 3,834,490 (Ford), while retractable into a housing attached below the bumper and under the vehicle body, does not solve the appearance problem of the step on the bumper, and is expensive to manufacture. Furthermore, none of these foldable bumper steps may be deployed from a retracted position or retracted from a deployed position when a trailer is attached to the vehicle.

Shiftable and pivotable bumpers are known for allowing ease of access to a cargo space with a surface below the bumper, for example in station wagons, as seen in U.S. Pat. No. 3,451,710 (Savell) and U.S. Pat. No. 2,672,363 (Buchanan). These pivotable bumpers are designed to provide a better access to a cargo floor located lower than the level of the top of the bumper. These, however, are not adapted to provide a step in order to reach a higher cargo space such as a truck bed, for example. Furthermore, they do not address the question of being able to deploy when a trailer is attached to the vehicle. Other pivotable bumpers, as the one disclosed in U.S. Pat. No. 5,678,872 (Slater) have a concealed stepping surface adequate to reach a higher cargo space. However, they still cannot be deployed or retracted when a trailer is attached to the vehicle.

Hence, the common drawback of all this prior art is that none of these solutions permits the use of its step at an adequate height to reach a high cargo area while having a trailer attached to the vehicle.

### SUMMARY OF THE INVENTION

It is an object of the present invention to provide a bumper assembly for a vehicle that overcomes or mitigates one or more disadvantages of known bumper assemblies, or at least provides a useful alternative.

It is another object of the present invention to provide a bumper assembly for a vehicle that comprises a step for convenient access to a cargo area of the vehicle without having to uncouple a trailer.

In accordance with an embodiment of the present invention, there is provided a bumper assembly for an automotive vehicle having a chassis and a longitudinal axis. The bumper assembly comprises an elongated frame and a first step pivotally attached to the frame. The elongated frame has a first end, a second end and a hitch clearance area between the first end and the second end. The frame is adapted to be attached to the chassis. The hitch clearance area is at least the width of a trailer hitch. The first step is attached to the frame between the first end and the hitch clearance area. The first step is pivotable from a stored position to a functionally deployed position. The first step is operative to receive at least a person on a stepping face when in the deployed position. The first step is operative to clear a projection of the hitch clearance area in the direction of the longitudinal axis of the vehicle.

In accordance with another embodiment of the present invention, there is provided a step assembly adapted to be installed on a bumper of an automotive vehicle having a width. The step assembly comprises a sub-frame and a step pivotably attached to the sub-frame. The step has a stepping face and an opposed cosmetic face. The step is operative to pivot from a stored position to a deployed position for withstanding at least the weight of a person. The stepping face is less than half of the width of the vehicle so that the step is adapted to be installed laterally off-centered from the vehicle.

In accordance with yet another embodiment of the present invention, there is provided an automotive vehicle having a chassis, a rear portion and a longitudinal axis. The rear portion comprises a first off-center step so as to clear a projection of a central hitch clearance area along the longitudinal axis. The first step has a first stepping face and is pivotable from a stored position to a deployed position for receiving at least a person on its first stepping face.

In accordance with still another embodiment of the present invention, there is provided an automotive vehicle having a rear portion that comprises a first offset door. The first offset door has a width and a lateral location on the rear portion. The rear portion further comprises a first offset step substantially matching the width and the lateral location of the first offset door. The first step has a first stepping face and is pivotable from a stored position to a deployed position for receiving at least a person on the first stepping face.

### BRIEF DESCRIPTION OF DRAWINGS

These and other features of the present invention will become more apparent from the following description in which reference is made to the appended drawings wherein:

FIG. 1 is a perspective view of a bumper assembly with its steps in their deployed position in accordance with an embodiment of the present invention.

FIG. 2 is a perspective view of the bumper assembly of FIG. 1 with its steps in their stored position.

FIG. 3 is a perspective view of a bumper assembly with a trailer attached to the vehicle in accordance with another embodiment of the present invention.

FIG. 4 is a perspective view of a bumper assembly in accordance with another embodiment of the present invention.

FIG. 5 is a perspective view of a step adapted to be installed on a vehicle in accordance with another embodiment of the present invention.

FIG. 6 is a perspective view of the rear section of a vehicle in accordance with another embodiment of the present invention.

FIG. 7 is a perspective view of a multiple step in accordance with another embodiment of the present invention.

### DETAILED DESCRIPTION OF THE INVENTION

The present invention is used in automotive vehicles, especially pick-up trucks, cutaway trucks or chassis-cabs. As these vehicles are often used for work, it is frequent that a trailer is towed behind the vehicle when the cargo area is not enough to carry all necessary material. Since these vehicles have their cargo area high from the ground, a step is used to gain access to it. Contrarily to the prior art, the step of the present invention may provide such access to the cargo area while a trailer is connected to the vehicle, or when the vehicle is equipped with offset vertical back doors.

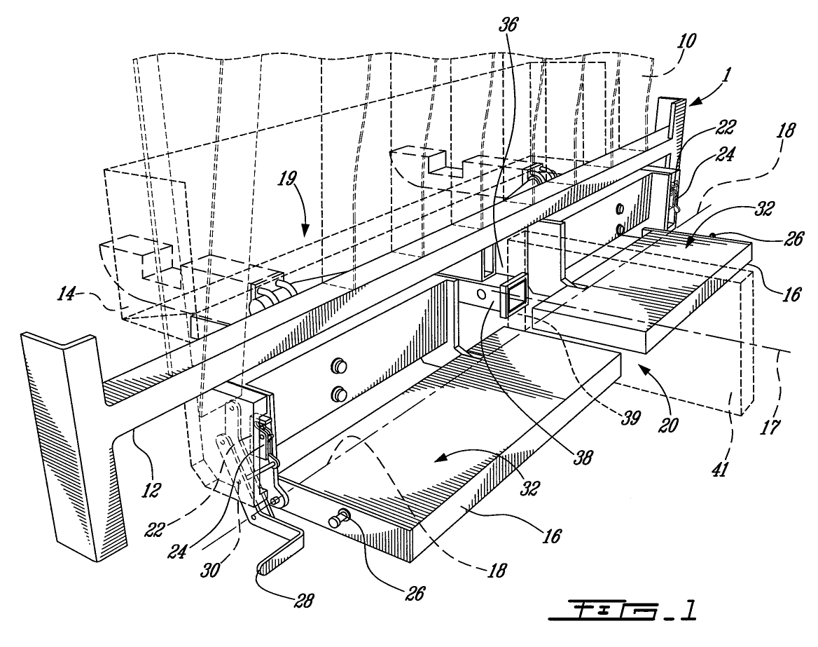

In a particular embodiment, FIG. 1 depicts the details of the invention. A bumper assembly 1 is installed on an automotive vehicle 10, which in most cases is either a pick-up truck, or a truck. The bumper assembly 1 comprises an elongated frame 12 attached to the chassis 14 of the vehicle 10. Although it is possible to use only one step 16, two steps 16 are shown which pivotably attach to the frame 12. The steps 16 pivot independently of each other around their own pivot axis 18 from a stored position to a deployed position. Although both steps 16 may be installed at different heights and with their pivot axis 18 substantially parallel to each other, it is preferred to have the steps 16 aligned so that their pivot axis 18 are co-axial and therefore common. Both steps 16 are positioned so that when they are deployed, they are preferably vertically located approximately midway between the ground and the floor 19 of the cargo area of the vehicle 10. Both steps 16 are off-center, or laterally offset from a longitudinal axis 17 of the vehicle 10, creating a gap 20 between both steps 16. The longitudinal axis 17 is laterally centered on the vehicle 10. When possible, symmetrical steps 16 may be used. To secure the steps 16 during traveling, it is suggested that the bumper assembly 1 be equipped with a locking mechanism 22 that locks the steps 16 in their stored position. The locking mechanism 22 may be of any suitable type and may lock either both or only one step 16 at a time. Here, a latch 24 is installed on the frame 12 so that when the step 16 is retracted to its stored position, a knob 26 engages the latch 24. The latch 24 may be activated by a lever 28 through a lever mechanism 30. The lever 28 is itself preferably activated by foot. This conveniently frees the hands of the user.

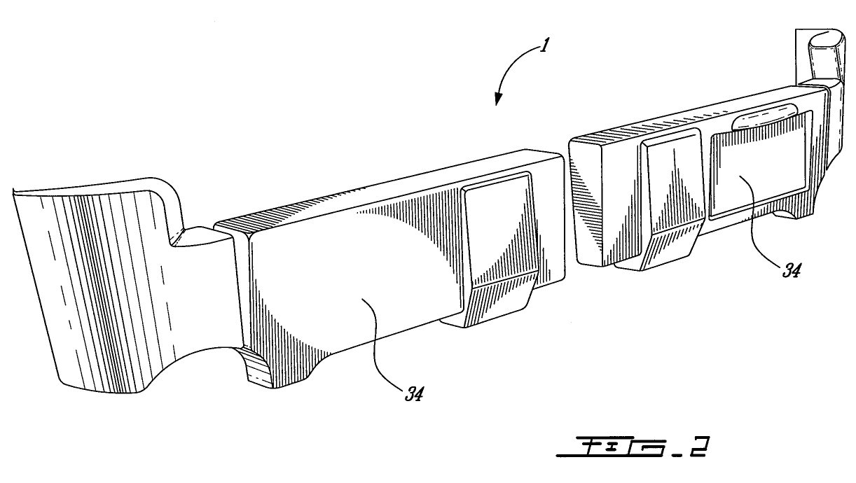

Concurrent reference is now made to FIGS. 1 and 2. The steps are provided with a stepping face 32 and a cosmetic face 34. The stepping face 32 is adapted to be stepped on, preferably being made of metal with a gripping surface to prevent slipping. The cosmetic face 34 may be made of either metal or plastic and is designed to provide an aesthetically pleasing appearance to the bumper assembly 1. The step 16 may be made of one or more parts. Hence, the step 16 may have independent stepping face 32 and cosmetic face 34 assembled together or alternatively, be made of a single part, such as a blow molded plastic part, for example.

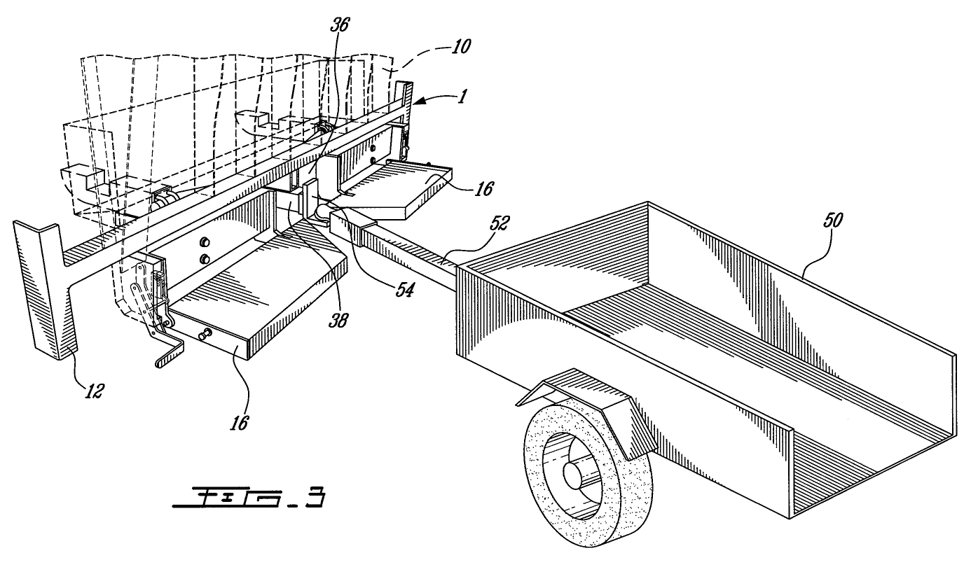

Concurrent reference is now made to FIGS. 1 and 3. FIG. 3 shows a trailer 50 attached to a ball mount 54 inserted in a hitch 38. Depending on the height of installation of the bumper assembly 1 on the vehicle 10, the frame 12 may be designed with an opening or recess portion 36 in its center such as to free space for installing the hitch 38. A hitch clearance area 39 defines an area of minimal width to provide the possibility of deploying the steps 16 without having to disconnect the trailer 50 that is attached to the vehicle 10. A projection of the hitch clearance area 39 creates a volume 41 where the steps 16 must not protrude. The steps 16 are installed off-center, creating the gap 20 between them, of at least the same width as the hitch clearance area width, so that at least one of them may be deployed even when a neck 52 of the trailer 50 is fitted to the ball mount 54 of the hitch 38 and even when the trailer 50 is not aligned with the longitudinal axis 17 of the vehicle 10. The gap 20 provides sufficient space for the neck 52 of the trailer 50 to fit in the volume created by the projection of the hitch clearance area 39. For example, the width of the hitch clearance area 39, or the gap 20 may require being at least 3 inches. Moreover, when the vehicle 10 is equipped with two rear doors, it is possible to deploy only one step 16 and open only one door to access the interior of the back of the vehicle 10. Optionally, the steps 16 may be designed such that the gap 20 is taper towards the hitch 38 such as to provide the flexibility of being able to deploy the steps 16 when the trailer 50 is not aligned with the longitudinal axis 17 of the vehicle 10, as shown in FIG. 3.

In operation, the steps 16 are locked by the latch 24 in their stored position substantially upright, substantially concealing their stepping surface 32 against the frame 12 or the back of the vehicle 10. When the user needs access to the inside of the cargo area of his vehicle 10, he deploys one of the steps 16 by pressing on the lever 28 which activates the latch 24 through the lever mechanism 30. The step 16 pivots by approximately 90 degrees from its stored position, which was approximately vertical, to its deployed position which is approximately horizontal. The frame 12 and the steps 16 are adapted to support at least the weight of the user when in the deployed position. The user may deploy only one, or both of the steps 16. When finished, the user pivots the step 16 back in its stored position by lifting the step 16 until the knob 26 engages the latch 24 and gets secured by it.

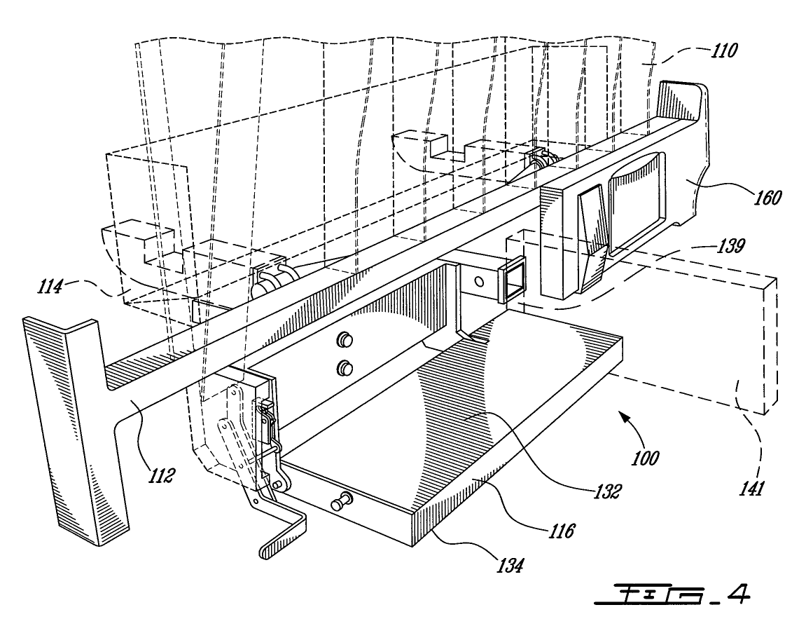

It is clear to those skilled in the art that, in a more general manner, the bumper assembly of the present invention could possibly include only one step. To illustrate such an embodiment, reference is now made to FIG. 4. Hence, the bumper assembly 100 includes a frame 112 adapted to be attached to a chassis 114 of a vehicle 110. A step 116 pivotably attaches to the frame 112. The step 116 is placed between the end of the frame 112 and a hitch clearance area 139 located between both ends of the frame 112 so that no part of the step 116 protrudes within a volume 141 defined by the projection of the hitch clearance area 139. The step 116 pivots from its stored position to its functionally deployed position where a person may stand on its stepping face 132. For a more aesthetically pleasing appearance, the step 116 may be equipped with the cosmetic face 134 (hidden in FIG. 4) opposed to the stepping face 132. In this particular embodiment, the portion of the frame 112 located between the hitch clearance area 139 and the other end of the frame 112 may be equipped with other devices such as a lifting platform (not shown) or simply with a half-bumper 160 that does not double as a step and therefore does not pivot. Preferably, though, this static portion of the frame 112 is made to look like the cosmetic face 134 of the step 116 such that when the step 116 is in its stored position, the bumper assembly 100 has an aesthetically pleasing and mostly symmetrical appearance.

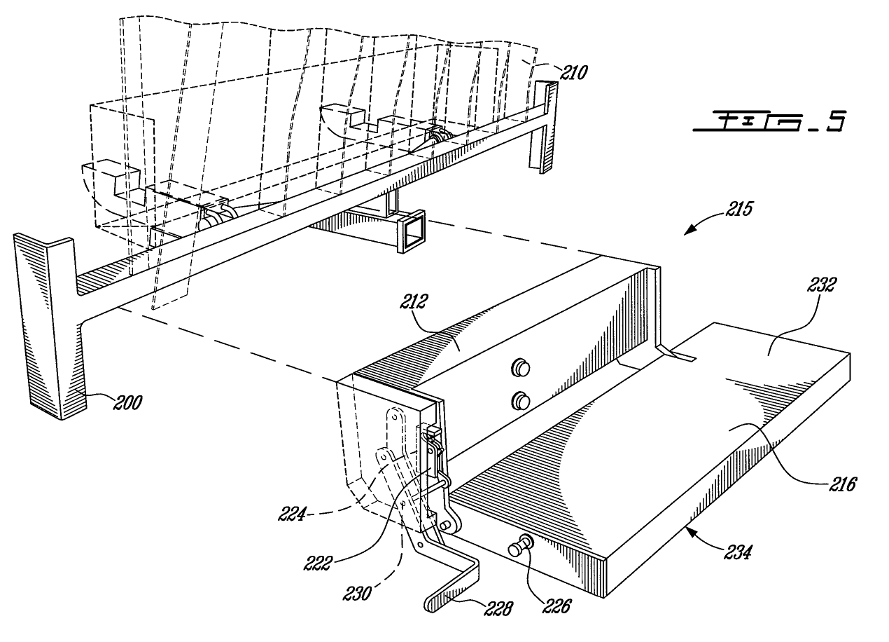

Alternatively, the invention provides for a pivotable step assembly 215 adapted to be installed on an automotive vehicle bumper 200 as shown in FIG. 5. The step assembly 215 comprises a sub-frame 212 on which the step 216 pivots from its stored position to its deployed position where its stepping face 232 is exposed. This position is operative to withstand at least the weight of a person. The step 216 is also equipped with a cosmetic face 234 (hidden in FIG. 5) opposed to the stepping face 232 so that when the step 216 is installed on a vehicle 210 and is in its stored position, the cosmetic face 234 is visible and provides a nice appearance to the vehicle 210. Preferably, the cosmetic face 234 is integrated with the aesthetic appearance of the vehicle 210. The step assembly may include a locking mechanism 222 that locks the step 116 in its stored position. The locking mechanism 222 may be a latch 224 installed on the frame sub-212 so that when the step 116 is retracted to its stored position, a knob 226 engages the latch 224. The latch 224 may be activated by a lever 228 through a lever mechanism 230.

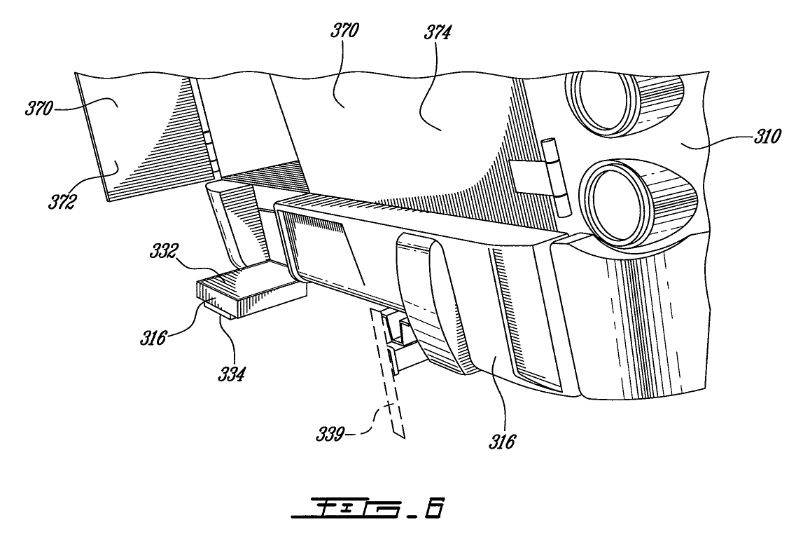

In another embodiment of the invention, a vehicle 310 is equipped with steps 316 that are aligned with doors 370 at the back of the vehicle 310, such as shown in FIG. 6. For example, the vehicle 310 may be equipped with asymmetrical doors, where, for some reason, a door 370 may be wider than the other. In this case, it is convenient to have the steps 316 of approximately the same width as the doors 370 so that only one step 316 may be deployed when only one door 316 is opened. Hence, if the door 370 extends from a region near a side of the vehicle 310 past its center, then the step 316 matches the width and the lateral location of the door 370. FIG. 6 shows one door 370 opened with one step 316 deployed. The left door 372 is shorter than the right door 374. It is also possible to have a vehicle equipped with only one offset door 370 and only one matching offset step 316 while the other section of the bumper is fixed. Of course, the steps 316 are still provided with a stepping face 332 and may be provided with a cosmetic face 334. Similarly, the steps may still be equipped with a locking mechanism. Furthermore, if the steps are to equip a vehicle equipped with a hitch, it may be preferable to have the step 316 aligned with the wider door 374 shorter than the width of the door 374 such as to clear the hitch clearance area 339.

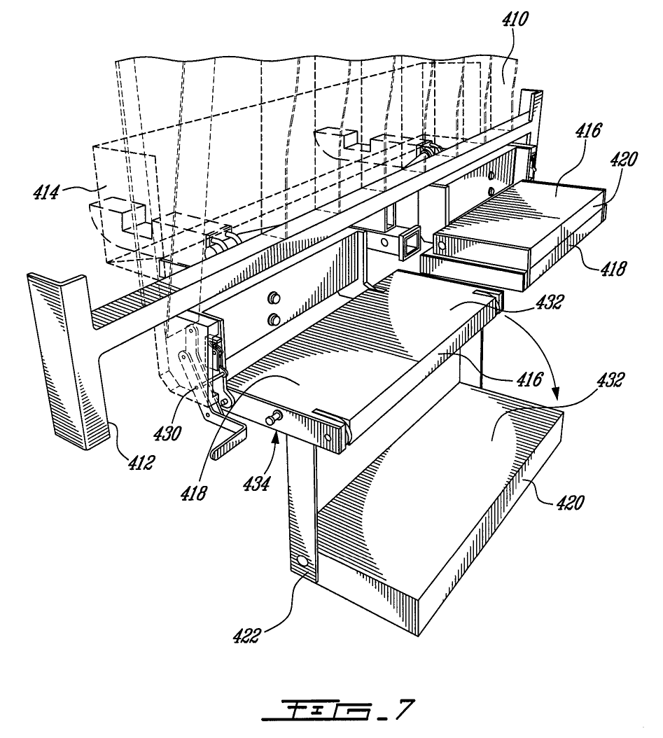

Turning now to FIG. 7, there is depicted another embodiment of the invention adapted most particularly for vehicles having a cargo area that is very high above the ground, such as modified pick-up trucks or large tractor-trailers, for example. In the present particular example, a tractor-trailer 410 is equipped with two steps 416 having two levels. One is shown deployed while the other is shown partially folded back on itself, with the first level deployed. The step 416 has at least two levels, a first level 418 and a second level 420, each having a stepping face 432. The first step 418 is pivotally attached to a frame 412 which itself is attached to the trailer chassis 414. A second level 420 is pivotally attached to linkages 422, which are themselves pivotally attached to the first level 418. Linkages 422 may be designed either in two separate parts or in one part. In use, the first level 418 is deployed first. Then, the second level 420, resting on the first level 418, is deployed along with the linkages 422. The second level 420 and the linkages form now a 90° angle below the first level 418. The second level 420 is further pivoted another 90° with respect to the linkages 422 to adopt its fully deployed position, as shown, where its stepping face 432 is capable of receiving at least the weight of a person. In order to store the step 416, the reverse operation is performed: First, the second level 420 is pivoted approximately 90° to a substantially vertical position in between both linkages 422. Then, both linkages 422 and the second level 420 are pivoted 2700 until they rest on the first level 418. The first level 418, along with the linkages 422 and the second level 420 are then rotated 90° to a stored position against the frame 412. The first level 416 is equipped with a cosmetic face 434, opposed to its stepping face 432. Alternatively, the step 416 may comprise more than two levels. The step 416 may also be equipped with a locking mechanism 430, similar to the locking mechanism described previously. The tractor-trailer 410 may be equipped with one or more steps 416. The step 416 may also be adapted to other vehicles.

It will of course be appreciated that many modifications and alternative embodiments are possible within the broad scope of the present invention. For example, the rotation of the steps 16 from a stored position to a deployed position and back could be assisted electrically, hydraulically, pneumatically or by a mechanical mechanism. The rotation of the steps 16 from a stored position to their deployed position and back may be done independently or simultaneously, manually or through a mechanism. Also, in some situations, in may be desirable to have more than two steps 16.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

I claim:

1. A bumper assembly for an automotive vehicle having a chassis and a longitudinal axis, the bumper assembly comprising:
an elongated frame having a first end, a second end and a hitch clearance area between said first end and said second end, said frame being adapted to be attached to the chassis, said hitch clearance area being at least the width of a trailer hitch; and
a first step pivotably attached to said frame between said first end and said hitch clearance area, said first step being pivotable from a stored position to a functionally deployed position, said first step being operative to receive at least a person on a stepping face when in said deployed position,
wherein said first step is operative to clear a projection of said hitch clearance area in the direction of the longitudinal axis.

2. The assembly of claim 1 further comprising a second step pivotably attached to said frame between said second end and said hitch clearance area, said second step being pivotable from a stored position to a functionally deployed position, said second step being operative to receive at least a person when in said deployed position, said second step being operative to clear a projection of said hitch clearance area in the direction of the longitudinal axis.

3. The assembly of claim 2 wherein said first step and said second step respectively pivot around a common pivot axis.

4. The assembly of claim 3 wherein said first step and said second step are operative to pivot by approximately 90 degrees.

5. The assembly of claim 4 wherein said frame has an opening in said hitch clearance area for accommodating a hitch to pass through said opening when said assembly is installed on the vehicle.

6. The assembly of claim 3 wherein said first step and said second step further comprise a cosmetic face opposed to said stepping face so that when said first step and said second step are in said stored position, said cosmetic face is visible and said stepping face substantially faces said frame.

7. The assembly of claim 6 further comprising at least one locking mechanism adapted to lock at least one of said first and said second steps in said stored position.

8. An automotive vehicle having a chassis, a rear portion and a longitudinal axis, the rear portion comprising a first off-center step so as to clear a projection of a central hitch clearance area along said longitudinal axis, said first step having a first stepping face and being pivotable from a stored position to a deployed position for receiving at least a person on said first stepping face.

9. The vehicle of claim 8 wherein said step is attached to said rear portion by a bumper assembly having a frame, said frame being connected to said chassis.

10. The vehicle of claim 9 wherein said rear portion further comprises a second off-center step so as to clear the projection of said central hitch clearance area along said longitudinal axis, said second step having a second stepping face and being pivotable from a stored position to a deployed position for receiving at least a person on said second stepping face, said first step and said second step having a common pivot axis.

11. The vehicle of claim 10 wherein said first step and said second step are operative to pivot by approximately 90 degrees.

12. The vehicle of claim 11 wherein said first step and said second step each have a respective first cosmetic face and second cosmetic face, said first and said second cosmetic faces being respectively opposed to said first stepping face and said second stepping face so that when said first step and said second step are in said stored position, said first and second cosmetic faces are visible and said first and second stepping faces substantially face said frame.

13. The vehicle of claim 12 further comprising at least one locking mechanism adapted to lock at least one of said first and said second steps in said stored position.

14. A step assembly adapted to be installed on a bumper of an automotive vehicle having a width, the step assembly comprising:
a sub-frame; and
a step pivotably attached to said sub-frame, said step having a stepping face and an opposed cosmetic face, said step being operative to pivot from a stored position to a deployed position for withstanding at least the weight of a person, the stepping face being less than half of the width of the vehicle so that said step is adapted to be installed laterally off-centered from the vehicle.

15. The step assembly of claim 14 further comprising a locking mechanism fixed on said sub-frame to lock said step in said stored position and wherein said step is operative to pivot by approximately 90 degrees and

16. The step assembly of claim 14 wherein said step defines a first level, said step assembly comprising a second level pivotably attached to said first level, said second level being operative to pivot from a stored position against said stepping face of said first level to a deployed position for withstanding at least the weight of a person.

17. An automotive vehicle having a rear portion comprising a first offset door having a width and a lateral location on said rear portion, said rear portion further comprising a first offset step substantially matching said width and said lateral location of said first offset door, said first step having a first stepping face and being pivotable from a stored position to a deployed position for receiving at least a person on said first stepping face.

18. The vehicle of claim 17 wherein said rear portion further comprises a second offset step so as to match a width and a lateral location of a second offset door, said second step having a second stepping face and being pivotable from a stored position to a deployed position for receiving at least a person on said second stepping face.

19. The vehicle of claim 18 wherein said first step and said second step respectively have a first and a second cosmetic face respectively opposed to said first and said second stepping face so that when said first step and said second step are in said stored position, said first and said second cosmetic faces are visible and said first and said second stepping faces substantially face said rear portion.

20. The vehicle of claim 19 further comprising at least one locking mechanism adapted to lock at least one of said first and said second steps in said stored position.
